(19) United States
(12) Patent Application Publication
(10) Pub. No.: US 2003/0019564 A1
(43) Pub. Date: Jan. 30, 2003

(54) Thermally conductive adhesive sheet

(75) Inventors: Kenji Shimada, Tokyo (JP); Kazuyuki Ohya, Tokyo (JP)

Correspondence Address: SUGHRUE MION, PLLC, 2100 Pennsylvania Avenue, N.W., Washington, DC, 20037-3213, US

(73) Assignee: MITSUBISHI GAS CHEMICAL COMPANY, INC.

(21) Appl. No.: 10/200,448

(22) Filed: Jul. 23, 2002

(30) Foreign Application Priority Data
Jul. 25, 2001 (JP) 224007/01

(51) Int. Cl. C03B 29/00

(52) U.S. Cl. 156/89.11

(57) ABSTRACT

A thermally conductive adhesive sheet which has electric insulation, a high conductivity and a small thermal expansion coefficient, obtained by impregnating an inorganic continuously porous sintered substrate having a thermal conductivity of 20 W/(mk) or more and a thickness of 0.1 to 2 mm with an organometallic compound, heat-treating the organometallic compound to decompose the organometallic compound and to form an oxide or a complex oxide on continuous pore surfaces, then impregnating a resin liquid into the inorganic continuously porous sintered substrate.

### FIELD OF THE INVENTION

The present invention is directed to a thermally conductive adhesive sheet using an inorganic continuously porous sintered substrate having electric insulation, a high thermal conductivity and a small thermal expansion coefficient. By taking advantage of its high thermal conductivity and small thermal expansion coefficient, for example, it is suitably used as an electric insulating adhesive sheet for securing the heat radiation of a semiconductor chip, etc.

### BACKGROUND OF THE INVENTION

Conventionally, a heat-radiating part is attached to semiconductor elements or electronic parts having a large heat generation quantity with an adhesive having a high thermal conductivity for heat radiation.

There are no bounds to increases in the density and performance of electronic and electrical products including semiconductor elements. As a result, a heat generation quantity per unit area or volume tends to increase considerably so that a conventional method is insufficient to radiate heat in some cases. Further, a package for an electronic part tends to decrease in thickness and size, so that auxiliary parts relevant to a power source such as a condenser or a diode, which parts can be contained in a conventional package, are exposed on a package surface. Further, a higher-frequency wave has come to be used so that there are caused problems such as generation of noises due to diffusion of an electromagnetic wave and a malfunction due to picking up the noises.

As for a heat radiation problem, for example, in the case of a semiconductor element having a heat generation quantity of approximately 30 W or less per a little less than 1 cm², the purpose of heat radiation is sufficiently attained by a method in which an alumina package is used and a heat-radiating part (for example, an aluminum alloy fin plate with a fan) is fixed to the package with a thermally conductive silicone adhesive, etc., or a method in which a heat-radiating part is fixed to a semiconductor element of a package using a mulitilayer board made of a resin with a thermally conductive adhesive having electric insulation.

However, a heat generation quantity has come to be high and there is a plan of a heat generation quantity of, for example, approximately 60W. The above methods are insufficient to radiate heat so that these methods can not be used. Further, when auxiliary parts are exposed because of a decrease in the thickness of a package, there is a problem that employing a conventional method as it is impairs reliability.

An increase in heat radiation quantity can be attained by an improvement in the performance of a heat radiating part and an increase in heat transfer to the above heat-radiating part.

Here, an increase in heat transfer quantity to the heat-radiating part is carried out by exposing a back surface of a semiconductor element and fixing the heat-radiating part to the back surface with an adhesive having a high thermal conductivity.

The adhesive used for the fixing is a composition obtained by dispersing a particle component having high thermal conductivity in a binder component. Highly thermally conductive particles include metals such as silver, copper and aluminum, ceramics such as aluminum oxide, magnesium oxide, aluminum nitride, silicon carbide, boron nitride and diamond and carbon materials such as graphite. Further, as the binder component, there is generally used an epoxy resin, a silicone resin or other resins.

The adhesive having a high thermal conductivity, e.g., approximately 30 to 60 W/(mk), is generally an adhesive containing a silver powder or the like, and it is high thermally conductive and electrical conductive. As an adhesive having electric insulation and a high thermal conductivity, there is diamond. However, it is expensive and is impractical.

As a result, even when an adhesive having a high thermal conductivity and electrical conductivity is used, essential is a method which is able to fix the heat-radiating part without a decrease in reliability because of exposed auxiliary parts, generation of noises due to diffusion of electromagnetic wave, and a malfunction due to picking up the noises.

### SUMMARY OF THE INVENTION

It is an object of the present invention to provide an inorganic continuously porous sintered substrate having electric insulation, a high thermal conductivity and a small thermal expansion coefficient.

It is another object of the present invention to provide an electric insulating adhesive sheet for securing the heat radiation of a semiconductor chip, etc.

That is, the present invention is directed to a thermally conductive adhesive sheet obtained by impregnating an inorganic continuously porous sintered substrate having a thermal conductivity of 20 W/(mk) or more and a thickness of 0.1 to 2 mm with an organometallic compound, heat-treating the organometallic compound to decompose the organometallic compound and to form an oxide or a complex oxide on continuous pore surfaces and then impregnating a resin liquid into the inorganic continuously porous sintered substrate. In the present specification, the term “adhesive” means “adhesive” and “tackiness”. Further, the term “resin liquid” refers to an organic solvent solution of a resin and a solventless resin liquid which is molten by heating at 50° C. or higher.

In the thermally conductive adhesive sheet of the present invention, preferably, the inorganic continuously porous sintered substrate is selected from aluminum nitride-boron nitride (AlN-h-BN), aluminum nitride-silicon carbide-boron nitride (AlN—SiC-h-BN), silicon carbide (SiC) and silicon nitride-boron nitride (Si₃N₄-h-BN).

In the thermally conductive adhesive sheet of the present invention, preferably, the resin liquid is a polyimide resin liquid or the like.

In the thermally conductive adhesive sheet of the present invention, preferably, the whole amount of the resin (total of the impregnated resin and the surface-attached resin) is 5 to 90% by volume, preferably 10 to 80%, based on the total volume of all pores.

### DETAILED DESCRIPTION OF THE INVENTION

The constitution of the present invention will be explained hereinafter.

First, the inorganic continuously porous sintered substrate used in the thermally conductive adhesive sheet of the present invention has a thermal conductivity of 20 W/(mk) or more, more preferably 30 W/(mk) or more, particularly preferably 45 W/(mk) or more, and a thickness of 0.1 to 2 mm. Concretely, it includes sintered bodies made of aluminum nitride-boron nitride (AlN-h-BN), aluminum nitride-silicon carbide-boron nitride (AlN—SiC-h-BN), silicon carbide (SiC), silicon nitride-boron nitride (Si₃N₄-h-BN), etc. Particularly, preferred is a sintered substrate using aluminum nitride (AlN) which has a small thermal expansion coefficient, a small temperature dependency and strong resistance against thermal shock and has a large thermal conductivity and boron nitride (h-BN) for improving processability, as essential components.

Before the impregnation with the resin, the present inorganic continuously porous sintered substrate is surface-treated for improving the affinity with the resin. The surface-treatment method is as follows. The inorganic continuously porous sintered substrate is impregnated with an organic solvent solution of a compound (chelate compounds, including salts) of an organometal, generally, under vacuum. The impregnated substrate is air-dried and then heated to pyrolyze the impregnated organometallic compound at 850° C. or less, particularly 600 to 750° C., and to form a coating of an oxide or a complex oxide of the above organometal not only on its surface but also on its internal pore surfaces.

The organometallic compound includes compounds containing aluminum, titanium, silicone or the like.

Further, the resin used for the resin liquid may be selected from various resins. In view of workability (impregnation, drying, processing, etc.) and facility of a mounting operation (bonding in a shorter time), thermoplastic resins (including waxes and greases) are preferred. Further, when thermoplastic resin is used, the number average particle diameter of the resin is preferably 10,000 or less, particularly preferably 5,000 or less, in terms of the securement of impregnation of the resin into fine pores. Since a heat-radiating part is fixed to a semiconductor element with a spring or a screw in most cases, the resin is not required to bond these materials strongly. Therefore, it is sufficient for the resin to have tackiness enough to prevent positional deviation during use. Further, MPU-exchange frequency becomes high for performance improvement. The upper temperature at the time of its assembly is generally 150° C. or less. From this respect, it is preferred to select a resin showing tackiness which allows easy detachment at 150° C. or less, generally 50° C. or more. From this respect, there may be used a resin liquid which is imparted with tackiness at 150° C. or less by using a melting-point depressant or the like. Further, when a use at 150° C. or higher as a heating element or a heat-radiating part is also considered, it is preferred to use resins which show tackiness at higher temperatures. Since the upper limit temperature in general use is 100° C. or lower, any one of general-purpose resins including waxes and greases, general-purpose engineering plastics and high heat-resistant resins may be used. These resins include silicone, wax, rosin, polyacrylate such as polymethylmethacrylate, polystyrene, an ABS resin, cellulose acetate, polycarbonate, polyphenylene oxide, polyamide, polyamideimide, polyetherimide, polyester, polyetherketone, polysulfone, and polyiimide.

Further, when the resin is impregnated as a resin solution, an example of the resin used and solvent will be explained. Examples of the solvent used for acrylate resins such as polymethylmethacrylate and polystyrene include acetone, methyl ethyl ketone and methylene chloride. Examples of the solvent for cellulose acetate include acetone and methyl cellosolve acetate. Examples of the solvent for polycarbonate include methylene chloride and ethylene chloride. Examples of the solvent for polyphenylene oxide include toluene, ethylene dichloride and chloroform. Examples of the solvent for nylon include resorcinol and ethanol. Examples of the solvent for polysulfone include methylene chloride and ethylene chloride. Examples of the solvent for ABS resin include toluene, acetone, methyl ethyl ketone and methylene chloride. Further, when polyimide is used, examples of the solvent includes dimethylformamide, dimethylacetoamide and N-methylpyrolidone.

For the impregnation of the resin, particularly when an inorganic continuously porous sintered substrate using a component which is decomposed by absorbing moisture in air, such as aluminum nitride, is used, it is also preferred for improving water resistance that the sintered substrate is impregnated with a resin solution having a low thermosetting resin concentration of 10% or less and then dried to preliminarily-cure or cure the resin and to form a thin resin film particularly on internal pore surfaces.

The impregnation rate of the resin is generally 5 to 90 vol %, preferably 5 to 80 vol %, more preferably 10 to 60 vol %. When the resin impregnation rate, i.e. the total amount of the impregnated resin and the surface-attached resin, is 5% by volume or less based on the total volume of all pores, undesirably, it is impossible to perform a high reliable bonding in thermocompression bonding to a heat sink or the like. When it exceeds 90% by volume, undesirably, there is a strong tendency for bonding with almost no bonding layer to become difficult when the bonding is carried out by thermocompression bonding, so that thermal conductivity significantly decreases.

The impregnation of the resin liquid into the present inorganic continuously porous sintered substrate is generally carried out under a reduced pressure. The pressure reduction degree is preferably higher. When the resin liquid contains an organic solvent, it is preferred to employ a pressure reduction degree of approximately a threshold value at which solvent of the resin solution does not boil. When a higher pressure reduction degree is used, the resin solution is cooled or a resin solution of a solvent having a higher boiling point is used.

Concretely, the present inorganic continuously porous sintered substrate is placed in an impregnation container of a vacuum impregnator, the resin liquid is supplied until the resin liquid covers the inorganic continuously porous sintered substrate, the sintered substrate is maintained therein for a time necessary and sufficient for the impregnation and then it is taken out. Here, there may be employed impregnation-promoting means like the following. The inside of the system is adjusted at a predetermined pressure reduction degree before the supply of resin liquid, a resin liquid which has been deaerated under a reduced pressure is gradually supplied until the resin liquid covers the present inorganic continuously porous sintered substrate and then the inorganic continuously porous sintered substrate is maintained under a reduced pressure for a predetermined period of time. Otherwise, operations composed of air-introduction, closing and decompression are carried out once or two or more times during the above maintenance period of time as required, as impregnation-promoting means. Further, ultrasonic vibration or low frequency vibration may be used as impregnation-promoting means.

After the inorganic continuously porous sintered substrate is taken out, an excess resin liquid adhering to the surface is removed by natural drop or the like, and, when the resin liquid contains an organic solvent, the solvent is removed by air-drying or with a hot-air dryer or a vacuum dryer.

Then, the inorganic continuously porous sintered substrate is post-processed to a size to be used, or the like, as required. When water or the like is used in the post-processing, the water is completely removed by washing with acetone or other hydrophilic organic solvents and sufficient drying.

By the way, for example, the maximum working temperature of MPU used in a personal computer and the like is generally 70 to 80° C. The maximum temperature usable for assembly such as bonding is approximately 150° C. or lower.

Thus, typical examples of the method for assembling (mounting) the thermally conductive adhesive sheet of the present invention includes the following methods. One example is (1) a method in which the present thermally conductive adhesive sheet is bonded and fixed to a heat-radiating part (heat sink, a plate with fin made of copper or an aluminum alloy) in a state where there is substantially no bonding layer, and the resultant adhesive sheet is bonded or closely fixed to a heat-radiating surface of MPU with a high thermally conductive adhesive. Other examples are (2) a method in which, in the fixation of a heat-radiating part to MPU with a fixture such as a spring, the present thermally conductive adhesive sheet is interposed between the heat-radiating part and a heat-radiating surface of MPU, and (3) a method in which, after the above (2), the thermally conductive adhesive sheet is heated up to approximately 50 to 100° C. to soften a resin and to reduce a resin layer.

The above method (1) is suitable for a use which necessarily requires a higher thermal conductivity. It is preferred to select a resin having heat resistance against 150° C. or higher for the bonding between the heat-radiating part and the present thermally conductive adhesive sheet. Therefore, it is also preferred to select such a resin as a resin used for the production of the present thermally conductive adhesive sheet. Further, when the above method (1) is applied to MPU having surface-exposed auxiliary parts, etc., (plural) portions of the above surface-exposed auxiliary parts and a heat-radiating surface of MPU become surface-protrusion portions. It is essential to secure insulation reliability between the heat-radiating surface, on which a high thermally conductive and electrically conductive adhesive is generally to be used, and the above surface-exposed auxiliary parts. For this reason, it is preferred to use a present thermally conductive adhesive sheet having a predetermined thickness for insulation in combination with a present thermally conductive adhesive sheet prepared by forming holes or concave portions sufficient for accepting the above-mentioned surface-protrusion portions such that the latter adhesive sheet is disposed on the former adhesive sheet.

The above method (2) is a method which is usable when a present thermally conductive adhesive sheet using a resin showing, at room temperature, tackiness enough to fill unevenness between MPU and a heat sink, etc., is used. Further, the above method (3) uses a present thermally conductive adhesive sheet employing a resin which can softens at approximately 50 to 100° C. This thermally conductive adhesive sheet has performance as an electric insulating sheet having thermally conductivity, while a fixture of the heat-radiating part is used for the bonding and fixing. From this viewpoint, it can be remarkably simply handled.

Concrete examples are explained in the above (1) and (2), while the concrete method of using the present thermally conductive adhesive sheet shall not be limited to the above methods so long as it is a method which can form an electric insulating layer on the entire surface.

### EXAMPLES

The present invention will be explained with reference to Examples hereinafter.

### Example 1

There was prepared an aluminum nitride-boron nitride-based porous sintered substrate (h-BN 20 wt %, bulk density 2.29 g/cm³, open porosity 20.8%, to be referred to as “AN1” hereinafter) having a thickness of 0.64 mm, a size of 125 mm×150 mm and a thermal conductivity of 55 W/(mk). Further, there was prepared an isopropyl alcohol (IPA) solution having an aluminum tris(ethylacetylacetonate) (article name: ALCH-TR, supplied by Kawaken Fine Chemicals Co., Ltd.,) concentration of 5 wt % (to be referred to as “Solution M1” hereinafter).

The above AN1 was placed in an impregnation container of a vacuum impregnator and Solution M1 was added until the solution M1 covered the AN1. The inside of the system was pressure-decreased to a pressure of 7 kPa or less, and the AN1 was maintained for 30 minutes. Then the AN1 was taken out and then allowed to stand at room temperature for 12 hours. These were placed in a muffle furnace, temperature-increased from room temperature up to 750° C. at a rate of 10° C./minute, maintained at 750° C. for 10 minutes and then allowed to cool, to obtain AN1 having pores on the surfaces of which an aluminum oxide was formed (to be referred to as “AN1-T” hereinafter).

There was prepared a solution of 10 wt % of a polyimide resin (number average molecular weight 10,000, trade name: RIKACOAT EN-20, supplied by New Japan Chemical Co., Ltd.) from 3,3′,4,4′-diphenylsulfonetetracarboxylic acid dianhydride and an aromatic diamine in N-methyl-2-pyrolidone (to be referred to as “Resin solution R1” hereinafter).

The above-obtained AN1-T was placed in an impregnation container of a vacuum impregnator and Resin solution R1 was added until it covered the AN1-T. The inside of the system was pressure-decreased to 1 kPa or less, and the AN1-T was maintained for 20 minutes.

The AN1-T impregnated with the resin solution R1 was taken out from the vacuum impregnator and it was dried with a dryer at 120° C. for 1 hour, to obtain a resin-impregnated AN1-T (to be referred to as “R-AN1” hereinafter).

The resin impregnation rate (total of the resin impregnated into pores and the resin adhering to the surface) of the R-AN1 was 56 vol % based on the total volume of all pores calculated from a porosity.

A copper foil having a thickness of 18 μm and a bonding surface Rz of 1.2 μm was thermocompression bonded to each surface of the R-AN1 under conditions of a maximum temperature of 220° C., a surface pressure of 0.4 MPa, and 10 minutes. The resultant sheet was cut, and the bonding surface of each copper foil was observed. The thickness of the bonding layer was 2 to 4 μm. Further, open pores located within 0.2 mm below the AN1 surface (interface with the bonding layer) were completely filled with the resin. This sample including the copper foils of both the surfaces was measured for thermal conductivity and it was 35 W/(mk).

### Referential Example 1

There was prepared a personal computer set for a temperature measurement.

A CPU package (trade name: Athlon 850 MHz, supplied by AMD) was used and as a mother board, trade name: K7TPro-A, supplied by Micro-Star International, which had no function of changing a load of a heat radiator, was used to prepare a personal computer set.

A spring-fixed type heat radiator (=heat sink, trade name: COOL MASTER CM12V, made of aluminum, with a fan) was used.

An electric insulating adhesive film having a thickness of 75 μm and a size of 30 mm×40 mm (thermal conductivity 1.5W/(mk), glass transition temperature 185° C., STAYATIK, supplied by TECHNO ALPHA Co., LTD, article number: 611) was temporally attached to a CPU mounting surface of the heat radiator. The heat radiator was fixed to the CPU package of the motherboard by using a spring.

“Super π (program: produced by KANEDA laboratory of the University of Tokyo)” calculation was executed using the above-prepared personal computer set by a setting of 2,090,000 figures at a room temperature of 25° C. An internal temperature of CPU at the 10th loop was displayed and it was 50° C.

### Example 2

A resin-impregnated AN2 (to be referred to as “R-AN2” hereinafter) was obtained by the same surface-treatment, resin-impregnation and drying as those in Example 1 except that AN1 used in Example 1 was replaced with an aluminum nitride-boron nitride-based porous sintered substrate (h-BN 13 wt %, bulk density 2.64 g/cm³, open porosity 11%, to be referred to as “AN2” hereinafter) having a thickness of 0.625 mm, a size of 125 mm×150 mm and a thermal conductivity of 85 W/(mk).

The resin impregnation rate of R-AN2 was 34 vol %.

A copper foil was bonded to each surface of the R-AN2 in the same manner as in Example 1. Each bonding layer thereof had a thickness of 3 to 5 Am. Further, open pores located within 0.2 mm below the AN2 surface (interface with the bonding layer) were completely filled with the resin. The thermal conductivity was 55 W/(mk).

Then, a heat radiation test was carried out by using the above-obtained R-AN2 as a thermally conductive bonding layer having electric insulation (heat spreader).

The same personal computer set as that used in Referential Example 1 was used and the following preparations were carried out.

The fan of the heat radiator was detached, the CUP mounting surface of the heat radiator made of aluminum was polished and washed, a 49.5 mm-square plate made of the above-obtained R-AN2 was thermocompression bonded under conditions of a maximum temperature 220° C., a surface pressure 0.4 MPa, and 10 minutes. Then, a surface of a portion of the thermocompression-bonded R-AN2 which portion corresponds to a contact surface with CPU was polished to completely remove the resin. Then, a soft aluminum foil (thermal conductivity 236 W/(mk)) of a thickness 0.015 mm×10 mm×12 mm was bonded to the above portion, and the fan was attached.

The CPU package was put in a socket of the motherboard. The above-prepared heat radiator was fixed thereon using a spring.

A CPU internal temperature was displayed in the same “super π” calculation as that in Referential Example 1 at room temperature of 25° C., and the internal temperature was 37° C.

### Example 3

There was prepared a solution (to be referred to as “Resin solution R3” hereinafter) of 30 wt % of a noncrystalline thermoplastic polyester resin (trade name: VYLON 53SS, number average molecular weight 15,000-20,000, glass transition temperature 114° C., supplied by Toyobo Co., Ltd.) in a mixed solvent of methyl ethyl ketone/toluene (1/1).

The same AN1-T as that in Example 1 was placed in an impregnation container of a vacuum impregnator and Resin solution R3 was added until it covered the AN1-T. The pressure in the system was adjusted to 1 kPa or lower, and it was maintained for 20 minutes.

The resin R1-impregnated AN1-T was taken out from the vacuum impregnator, then naturally dried for 5 hours, and dried by a dryer at 120° C. for 1 hour to obtain a resin-impregnated AN1-T (to be referred to as “R3-AN1” hereinafter).

The resin impregnation rate (total of the resin impregnated into pores and the resin adhering to the surface) of the R3-AN1 was 48 vol % based on the total volume of all pores calculated from a porosity.

A plate having a size of 49.5 mm×49.5 mm was cut out from the above R3-AN1. There was prepared a constitution in which this plate was used in place of the adhesive film of Referential Example 1 and it was disposed on a silicone chip-exposed surface of the CPU package. A thermometer was fixed to the heat radiator, hot air was sent with a hair dryer and heating was carried out for approximately 10 minutes while maintaining a thermometer temperature at 80 to 90° C.

A CPU internal temperature was displayed in the same “super π” calculation as that in Referential Example 1 at room temperature of 25° C., and the internal temperature was 41° C.

### Referential Example 2

A commercially available thermally conductive layer having electric insulation (heat spreader) was used, a personal computer set was prepared for a temperature measurement, and a heat radiation test was carried out.

A CPU package (trade name: Athlon XP 1700+, supplied by AMD) was mounted on a motherboard (trade name: GA-7VTXE, supplied by Gigabyte Technology).

As a heat radiator, a spring-fixed type heat radiator with a fan (=heat sink, an accessory of the CPU package) was used. A resin adhering to a CPU mounting surface of the heat radiator was carefully removed with a solvent. A lower-hardness heat-radiating silicone rubber sheet (trade name: TC50TXS, supplied by Shin-Etsu Silicones) having a thickness of 0.5 mm and a size of 25 mm×25 mm was quietly placed on the CPU. Then, the heat radiator was fixed to the motherboard, on which the CPU package had been mounted, by a predetermined method.

“Super π” calculation of 4,190,000 figures was executed using the above-prepared personal computer set at a room temperature of 22° C. The temperature of CPU increased up to 82° C. as a maximum temperature.

### Example 4

In Example 1, AN-1 was replaced with an AN2 board having a size of 125 mm×150 mm×0.3 mm, and the same surface treatment was carried out to obtain AN2 having pores on the surfaces of which an aluminum oxide was formed (to be referred to as “AN2-T” hereinafter).

There was prepared a solution (to be referred to as “Wax solution 1” hereinafter) of 40 wt % of a mixed wax (trade name: Sky liquid, supplied by Nikka Seiko K.K.) of a purified rosin and a modified acrylic resin in isopropyl alcohol.

AN2-T was placed in a container for impregnation, Wax solution 1 was added until it covered the AN2-T. The container with AN2-T in it was placed in a vacuum impregnator, the inside of the system was pressure-decreased to 7 kPa or less, and the container with AN2-T in it was maintained for 30 minutes. The AN2-T which had been impregnated with Wax solution 1 was taken out from the container at a constant rate of 50 mm min⁻¹, and then dried at 70° C. for 30 minutes, to obtain a wax-solution-1-impregnated AN2-T (to be referred to as “W1-AN2” hereinafter).

The resin impregnation rate (total of the resin impregnated into pores and the resin adhering to the surface) of the W1-AN2 was 45 vol % based on the total volume of all pores calculated from a porosity.

W1-AN2 was used as an electric insulating heat spreader, the same personal computer set as that used in Referential Example 2 was prepared, and a heat radiation test was carried out.

A fan of the heat radiator was detached, a resin adhering to a CPU mounting surface was carefully removed with a solvent, and it was heated up to approximately 90° C. with a hot plate having a temperature of approximately 120° C. W1-AN2 having a thickness of 0.3 mm and a square size of 25×25 mm was placed on a CPU contact portion of the heat radiator and marginal portions were pressed down for 3 minutes. The power source of the hot plate was turned off to terminate the heating. The heat radiator was allowed to cool to room temperature. Then, the fan was attached to the heat radiator and the heat radiator was fixed to the motherboard, on which the CPU package had been mounted, by a predetermined method.

“Super π” calculation of 16,770,000 figures was executed using the above-prepared personal computer set at a room temperature of 22° C. for decreasing the thickness of a resin layer between the CPU and the W1-AN2. In this calculation, the temperature of CPU was temporally increased up to 70° C. but it was immediately decreased to 65° C. Then, “super π” calculation of 4,190,000 figures was executed but the temperature of CPU was increased up to only 65° C. as a maximum temperature.

### Example 5

There was prepared a solution (to be referred to as “Wax solution 2” hereinafter) of 20 wt % of a mixed wax (trade name: Sky liquid, supplied by Nikka Seiko K.K.) of a purified rosin and a modified acrylic resin in isopropyl alcohol.

AN2-T was placed in a container for impregnation, Wax solution 2 was added until it covered the AN2-T. The container with AN2-T in it was placed in a vacuum impregnator, the inside of the system was pressure-decreased to 7 kPa or less, and the container with AN2-T in it was maintained for 30 minutes. The AN2-T which had been impregnated with Wax solution 2 was taken out from the container and then dried at 70° C. for 30 minutes, to obtain a wax-solution-2-impregnated AN2-T (to be referred to as “W2-AN2” hereinafter).

A silicone oil compound (trade name: G747, supplied by Shin-Etsu Silicones) for heat radiation was thinly applied to both surfaces of the W2-AN2, to obtain W2-AN2 having adhesive layers formed on the surfaces (to be referred to as “S-AN2” hereinafter).

The resin impregnation rate of the S-AN2 was 42 vol % based on the total volume of all pores calculated from a porosity.

A personal computer set was prepared in the same manner as in Referential Example 2 except that TC50TXS was replaced with S-AN2 having a thickness of 0.3 mm and a square size of 25×25 mm. “Super π” calculation of 4,190,000 figures was executed using the above-prepared personal computer set at a room temperature of 23° C. A CPU temperature was increased up to only 54° C. as a maximum temperature.

### Example 6

8 wt % of a monoester compound (trade name: CLOVAX 100-10S, melting point 41° C., supplied by Nippon Kasei Chemical Co.,Ltd.) as a melting-point depressant was added to a noncrystalline thermoplastic polyester resin (trade name: VYLON GK590, number average molecular weight 5,000˜8,000, glass transition temperature 15° C., softening point 110° C., supplied by Toyobo Co., Ltd.), and the mixture was heated at 150° C. to prepare a mixed resin (to be referred to as “Resin 1” hereinafter).

Resin 1 which had been heated to 150° C. was thinly applied to both surfaces of W1-AN2, and then it was allowed to cool to room temperature, to obtain W1-AN2 having adhesive layers formed on the surfaces (to be referred to as “R2-AN2” hereinafter).

The resin impregnation rate of the R2-AN2 was 45 vol % based on the total volume of all pores calculated from a porosity.

A personal computer set was prepared in the same manner as in Referential Example 2 except that TC50TXS was replaced with R2-AN2 having a thickness of 0.3 mm and a square size of 25×25 mm. “Super π” calculation of 4,190,000 figures was executed using the above-prepared personal computer set at a room temperature of 23° C. A CPU temperature was increased up to only 54° C. as a maximum temperature.

TABLE 1

| | resin | CPU maximum temperature in |
|---|---|---|
| | impregnation rate | Super π calculation of |
| | (vol %) | 4,190,000 figures, (° C.) |
| Referential | — | 82 |
| Example 2 | | |
| Example 4 | 45 | 65 |
| Example 5 | 42 | 54 |
| Example 6 | 45 | 54 |

### EFFECT OF THE INVENTION

As is evident from Examples and Referential Example, the present invention can provide a thermally conductive adhesive sheet having electric insulation, a high thermal conductivity and a low thermal expansion coefficient. For example, the thermally conductive adhesive sheet of the present invention can be suitably used as an electric insulation adhesive sheet for securing the heat radiation of a semiconductor chip having a largely increased heat generation quantity, whose practical use is difficult according to a conventional method. The thermally conductive adhesive sheet of the present invention has great significance industrially.

What is claimed is:

1. A thermally conductive adhesive sheet obtained by impregnating an inorganic continuously porous sintered substrate having a thermal conductivity of 20 W/(mk) or more and a thickness of 0.1 to 2 mm with an organometallic compound, heat-treating the organometallic compound to decompose the organometallic compound and to form an oxide or a complex oxide on continuous pore surfaces, and then impregnating a resin liquid into the inorganic continuously porous sintered substrate.

2. A thermally conductive adhesive sheet according to claim 1, wherein the inorganic continuously porous sintered substrate is selected from the group consisting of aluminum nitride-boron nitride (AlN-h-BN), aluminum nitride-silicon carbide-boron nitride (AlN—SiC-h-BN), silicon carbide (SiC) and silicon nitride-boron nitride (Si₃N₄-h-BN).

3. A thermally conductive adhesive sheet according to claim 1, wherein the whole amount of the resin (total of the impregnated resin and the surface-attached resin) is 5 to 80% by volume based on the total volume of all pores.
